(19) United States
(12) Patent Application Publication
(10) Pub. No.: US 2002/0074841 A1
(43) Pub. Date: Jun. 20, 2002

(54) Structure for adjusting distance between seat and handlebar of electric cart

(76) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/736,186

(22) Filed: Dec. 15, 2000

(51) Int. Cl. B60N 2/02

(52) U.S. Cl. 297/337

(57) ABSTRACT

A structure is designed to adjust the distance between seat and handlebar of an electric cart. The structure comprises a fixed base mounted on the seat post, a movable base fastened with the bottom of the seat and pivoted to the fixed base, and a locating member for locating the movable base at a desired position on the fixed base.

### FIELD OF THE INVENTION

The present invention relates generally to an electric cart, and more particularly to a structure for adjusting the distance between the seat and the handlebar of the electric cart.

### BACKGROUND OF THE INVENTION

As shown in FIG. 1, a person is seated in a prior art electric cart such that both hands of the person hold the steering handlebar. It is imperative that the distance between the seat and the handlebar is so appropriate as to enable the person to maneuver easily. The distance requirement varies from person to person, depending on body size of the person. The conventional electric carts are not equipped with a structure for adjusting the seat distance to meet the requirement of an individual.

### SUMMARY OF THE INVENTION

The primary objective of the present invention is to provide an electric cart with a structure for adjusting the distance between seat and steering handlebar of the electric cart, so as to meet the driving requirement of a person.

The structure of the present invention comprises a fixed base mounted on the seat of the electric cart, a movable base mounted at the bottom of the seat such that the movable base is pivoted with the fixed base, and a locating member for locating the movable base at a desired position on the fixed base.

### BRIEF DESCRIPTION OF THE DRAWINGS

FIG. 1 shows a schematic view of a poor seat distance of the prior art electric cart.

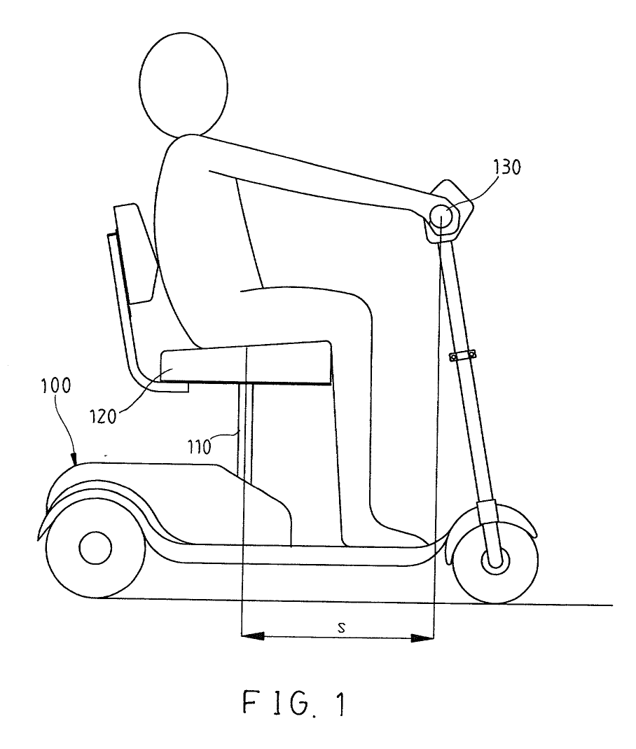

FIG. 2 shows a front view of a preferred embodiment of the present invention.

FIG. 3 shows a bottom view of the preferred embodiment of the present invention.

FIG. 4 shows a right view of the preferred embodiment of the present invention.

FIG. 5 shows a schematic view of the preferred embodiment of the present invention at work.

### DETAILED DESCRIPTION OF THE INVENTION

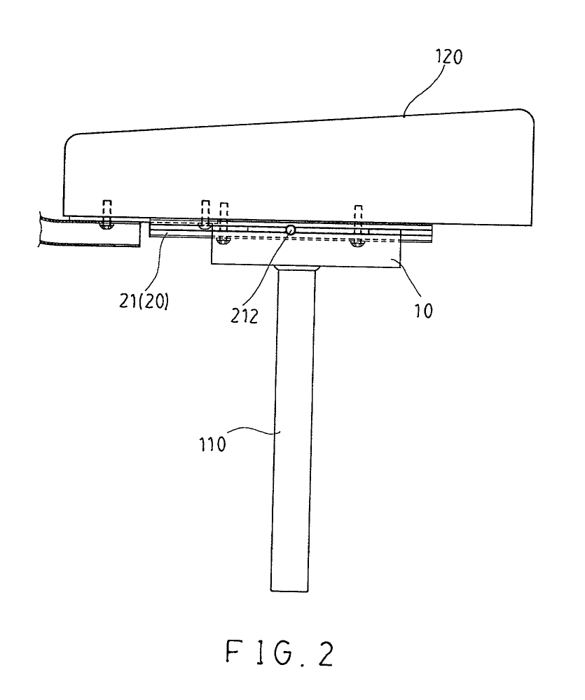

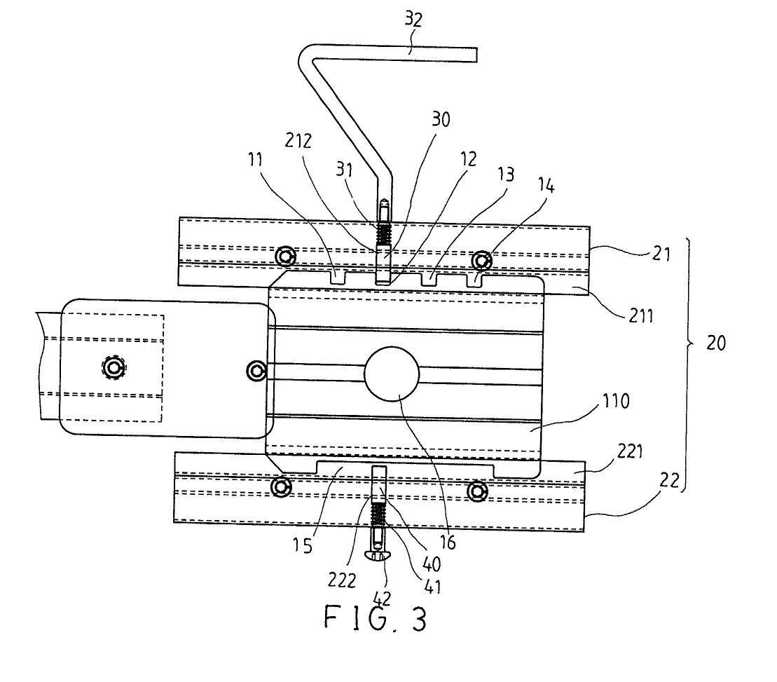

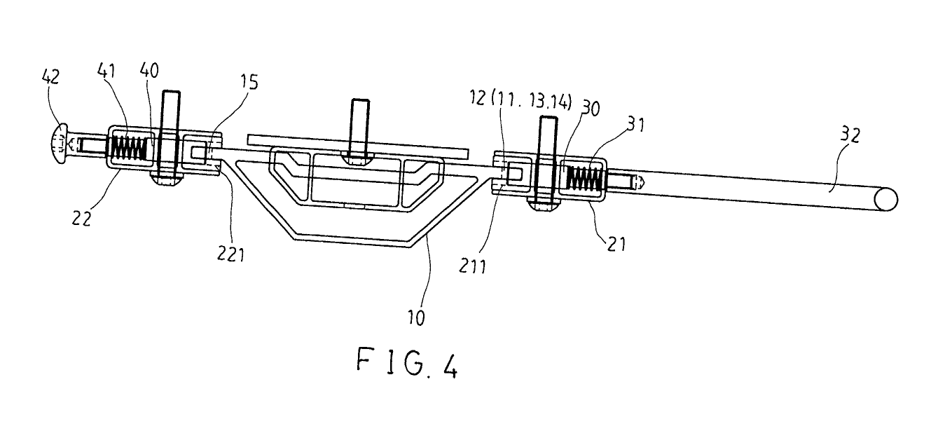

As shown in FIGS. 2-4, a structure embodied in the present invention is designed to adjust the distance between the seat 120 and the handlebar 130 of an electric cart 100. The structure comprises a fixed base 10, a movable base 20, a locating member 30, and a position confining member 40.

The fixed base 10 is disposed at the outer end of the seat post 110 and is provided at the upper end thereof with four locating slots 11, 12, 13, and 14. The fixed base 10 is further provided at the lower end thereof with a position confining slot 15, and in the middle thereof with a connection hole 16 for connecting the seat post 110.

The movable base 20 is disposed at the bottom end of the seat 120 and is formed of two movable members 21 and 22 parallel to each other and having in the inner side a slide slot 211, 221 for receiving two ends of the fixed base 10 such that the seat 120 can be moved forward or backward in relation to the fixed base 10. The first movable member 21 is provided in the outer side with a locating hole 212 extending into the slide slot 211. The second movable member 22 is provided in the outer side with a position confining hole 222 extending into the slide slot 221.

The locating member 30 is received at one end thereof in the locating hole 212 of the first movable member 21 such that the locating member 30 is capable of extending into the slide slot 211, so as to join with one of the four locating slots 11, 12, 13, and 14, thereby locating the seat 120 at a predetermined position. As the locating member 30 is pulled outward, the locating member 30 is moved away from the locating slots 11-14 of the fixed base 10 such that the locating member 30 is received in the locating hole 212, thereby causing the seat 120 to move back and forth for adjusting the distance between the seat 120 and the handlebar 130. The locating hole 212 is provided therein with a spring 31, which is intended to provide the locating member 30 with a spring force enabling the initial position of the locating member 30 to be located in the slide slot 211, so as to simplify the process of adjusting the seat distance. The locating member 30 is provided at the outer end with a grip 32 of a Vshaped construction.

The position confining member 40 is received at one end thereof in the position confining hole 222 of the second movable member 22 such that the position confining member 40 is capable of extending into the slide slot 221 and of being received in the position confining slot 15 of the fixed base 10, thereby allowing the seat 120 to be moved forward and backward to a limited extent. The position confining hole 222 of the second movable member 22 is provided therein with a spring 41 to provide the position confining member 40 with a spring force serving to enable the initial position of the position confining member 40 to be located in the slide slot 221, thereby simplifying the process of adjusting the seat distance. The position confining member 40 is provided at the outer end with a grip 42.

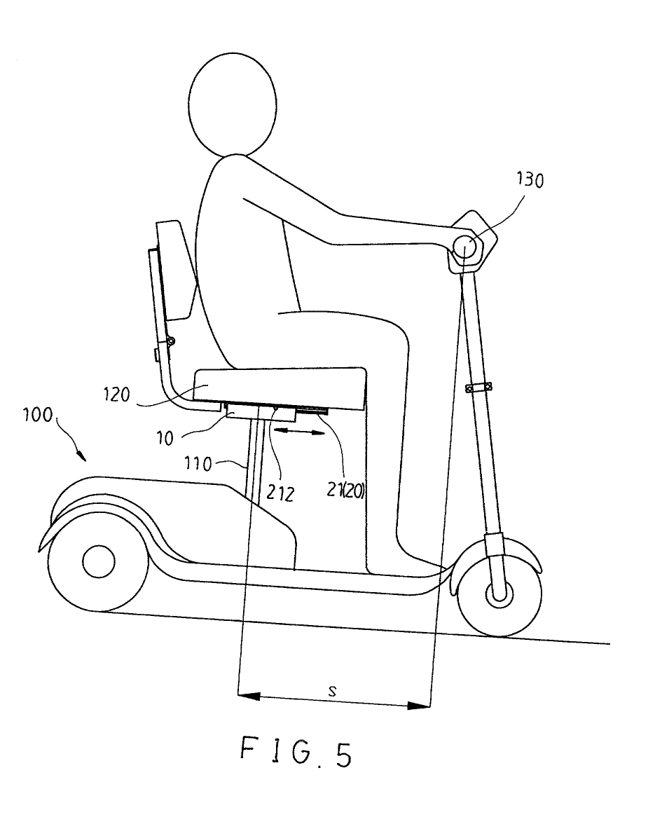

As shown in FIG. 5, a rider is seated on the seat 120 of the electric cart 100. The seat 120 is adjusted in position forward or backward by pulling outward the locating member 30. As soon as the position of the seat 120 is properly adjusted, the locating member 30 is let go so as to allow the locating member 30 to be acted on by the spring force of the spring 31 to move into one of the four locating slots 11-14 of the fixed base 10.

The seat 120 of the present invention can be detached by pulling outward the locating member 30 and the position confining member 40, thereby enabling the seat 120 to be removed from the front end or the rear end of the fixed base 10.

What is claimed is:

1. A structure for adjusting distance between seat and handlebar of an electric cart, said structure comprising:
a fixed base mounted on a seat post of the electric cart;
a movable base mounted at the bottom of the seat and pivoted to said fixed base such that the seat can be moved forward and backward along said fixed base; and
a locating member for locating said movable base at a predetermined position on said fixed base.

2. The structure as defined in claim 1, wherein said movable base is formed of two movable members which are parallel to each other and are mounted in the bottom of the seat whereby said two movable members are provided in an inner side with a slide slot.

3. The structure as defined in claim 2, wherein said fixed base is joined at two ends thereof with said slide slots of said two movable members, thereby enabling the seat to be moved forward and backward.

4. The structure as defined in claim 3, wherein said fixed base is provided at one end with a plurality of locating slots; wherein said locating member is disposed in one of said two movable members such that said locating member is moved through said one movable member to be received in one of said locating slots.

5. The structure as defined in claim 4, wherein said locating member is provided by a spring with a spring force enabling an initial position of said locating member to extend inward.

6. The structure as defined in claim 3, wherein said movable base is provided with a position confining member; wherein said fixed base is provided at one end with a plurality of locating slots and is disposed in one of said two movable members; wherein said fixed base is provided with a position confining slot to receive said position confining member, so as to confine the movement of the seat whereby said position confining member can be moved away from said position confining slot to enable the seat to be removed from said fixed base.

7. The structure as defined in claim 6, wherein said position confining member is provided by a spring with a spring force serving to enable an initial position of said position confining member to extend inward.
